(19) United States
(12) Patent Application Publication
(10) Pub. No.: US 2008/0143017 A1
(43) Pub. Date: Jun. 19, 2008

(54) Method and Apparatus for the Manufacture of Labeled Plastic Products

(75) Inventor: Hendricus Antonius Hoogland, Wormer (NL)

Correspondence Address: HOFFMANN & BARON, LLP, 6900 JERICHO TURNPIKE, SYOSSET, NY, 11791, US

(73) Assignee: I-PAC TECHNOLOGY N.V., CAPELLE A/D IJSSEL, NETHERLANDS (NL)

(21) Appl. No.: 11/795,544

(22) PCT Filed: Jan. 18, 2006
(86) PCT No.: PCT/NL06/00027

§ 371 Date: Feb. 15, 2008

(30) Foreign Application Priority Data
Jan. 19, 2005 (NL) 1028066

(51) Int. Cl. B29C 45/14; B29C 45/56

(52) U.S. Cl. 264/259; 425/116

(57) ABSTRACT

A method for the manufacture of plastic products in a mold (2), provided with at least one label, comprising the steps of: feeding a strip of film comprising at least one label; feeding-through the strip of film (34) over a joining surface of the mold in open condition such that said label (36) is positioned between two parts (47, 48) of a mold cavity of the mold; closing the mold such that said label is stored in said mold cavity; moving a moveable wall part (8) of the mold cavity within the mold cavity such that said label is pressed from said strip of film; injecting plastic into the mold cavity for forming a product therein such that the label is attached to or on the product.

The invention relates to a method for the manufacture of labeled plastic products.

Labels are used in plastic products for, for instance, embellishing products, applying information or finishing surfaces. To that end, a label can be applied onto the ready product by hand or by machine by, for instance, gluing. However, this is particularly expensive and time-consuming. That is why it is preferred that labeling be done in a mold during the manufacture of the product. This is designated, for instance, by the term in-mold labeling.

In-mold labeling can be realized by placing pre-cut labels in a stack in a labeling station. During a production cycle, each time, one label is taken from the stack with the aid of, for instance, a robot designed thereto, and is placed in a mold cavity of an open mold. Then, the mold is closed and plastic is injected into the mold cavity, against the label. After solidification, the product is taken from the mold cavity and a subsequent production cycle begins.

Instead of pre-cut labels, cutting means and/or punching means can be utilized in a labeling station. With these, labels are cut and/or punched out of a strip of film, which labels are directly picked up and transferred to a placing apparatus with which the labels are placed in a mold cavity of an open mold, whereupon a production cycle is completed as described hereinabove.

These known methods have as an advantage that operations can be automatic. However, a drawback is that the labels are to be picked up individually and moved inside the mold with the aid of robots, which slows down the production cycles.

An object of the invention is a method of the type described in the opening paragraph, with which labeled products can be manufactured in a simple manner. To that end, a method according to the invention is characterized by the features of claim 1.

With a method according to the present invention, a label is fed into a mold with the aid of a strip of film and is pressed from the film in the mold cavity with the aid of a movable wall part. Then, in the mold cavity, a plastic product is formed against the label by introducing plastic into the mold cavity. In particular, this is done in an injection-molding mold.

With this method, the advantage is achieved that the label needs not be picked up and/or transferred to an apparatus with which the label is brought into a mold cavity. In this way, the process is accelerated so that the cycle time can be shortened. Moreover, a simpler and/or less expensive apparatus can be utilized. A further advantage is that, as transferring is not necessary, the label can be given and held in a desired shape and position in a simpler manner. Furthermore, if the occasion arises, the extent to which the mold parts are to be moved apart can be limited, so that the cycle time can be shortened still further.

In a particularly advantageous embodiment, the label is, largely but not completely, cut loose or punched from the strip of film before the label is fed into the respective mold, at least mold part. As a result, the labels remains connected to the strip and can simply be fed by the strip into the mold cavity. Preferably, the label is then cut or punched from the strip such that on both sides of the strip, viewed in a feed-trough direction, an uninterrupted band of film is preserved. These bands can then simply be used for feeding the label through as far as into the mold cavity, at least between the mold parts and the mold cavity parts present therein. Moreover, the labels can thus be held and maintained in a desired position.

It is preferred that the plastic is introduced at the side of the label remote from the movable wall part, after which, with the aid of the movable wall part, the label is pressed against the plastic, while partially displacing the plastic. In this manner, a good connection between the plastic and the label is realized and the plastic can be prevented from inadvertently ending up behind the label. It is further preferred that the movable wall part be moved so rapidly from the retracted position in the direction of the extended position, that in plastic in the mold cavity adiabatic heat development occurs so that, as a result, the viscosity of the plastic will be reduced at least partly and the flow thereof becomes easier. As a result, relatively thin-walled products can be manufactured with relatively low injection pressure and closing force. Moreover, in this way, the label is even better prevented from becoming damaged by the plastic.

A strip can be used in which a series of labels are provided, preferably at least in a feed-through direction one behind the each other. Labels can also, for that matter, be placed next to each other, in rows. Per production cycle, a suitable number of labels are introduced into mold cavities and pressed loose to then be connected to plastic for forming a corresponding number of products. Optionally, several labels can be introduced into one mold cavity, for different parts of one product. Then, too, the labels can differ as to, for instance, form and/or material and/or position.

The invention further relates to an apparatus for the manufacture of plastic, labeled products. To that end, an apparatus according to the invention is characterized by the features of claim 9.

With an apparatus according to the present invention, in a mold cavity of a mold, a movable wall part is provided with which a label can be pressed from a strip of film. The label can be cut or punched out in the mold. It is preferred that in feed-through direction of the strip of film, before the mold, a labeling station is provided in which the or each label is virtually completely, but not entirely, cut loose from the strip of film, preferably all around. Here, it is ensured that the label remains connected to the strip at least two spaced apart and preferably opposite positions. To that end, on for instance both sides of the label, a band of film material can remain behind that is continuous and to which the label is connected. In the mold, only the remaining connections need to be pressed away by, for instance, a cutting movement, a punching movement or by tearing and/or pulling loose.

With the mold in closed position, the movable wall part in retracted position is preferably positioned such that a side thereof proximal to the mold cavity is approximately flush with the closing surface, at least with a part thereof. The strip of film, at least a label therein, extends at a relatively small distance from this side or abuts thereagainst. Herein, relatively small distance is understood to include smaller than the distance over which said movable wall part can be moved between the extended position and the retracted position, more particularly less than half this distance and preferably, at most, a quarter thereof. In this manner, it is ensured that virtually directly after the start of movement of said wall part, the label will be pressed from the strip.

In a particularly advantageous embodiment, drive means are provided for moving the at least one movable wall part from the retracted position in the direction of the extended position at a speed such that as a result, during use, in at least a part of the plastic in the mold adiabatic heat development occurs. This will reduce the viscosity of the plastic at least partly, so that flow of the plastic through the mold cavity is facilitated. Complete filling of the mold cavity can thus be achieved in a simpler manner with less pressure. Moreover, less closing pressure is required. A further advantage thereof is that the label will be less influenced by the plastic.

With a method or apparatus according to the invention, further, the advantage is achieved that particularly thin labels can be used, for instance some tens of μm, more particularly less than 50 μml, still more particularly less than 30 μm. Labels with a thickness of 10 to 20 μm can be processed. Naturally, much thicker labels can be processed too for that matter, with a method and apparatus according to the invention. The labels can be rectangular as well as irregularly shaped, and can be flat as well as bent.

In the further subclaims, further advantageous embodiments of a method and apparatus according to the invention are shown. In clarification of the invention, embodiments of the invention will be further elucidated with reference to the drawing. In the drawing:

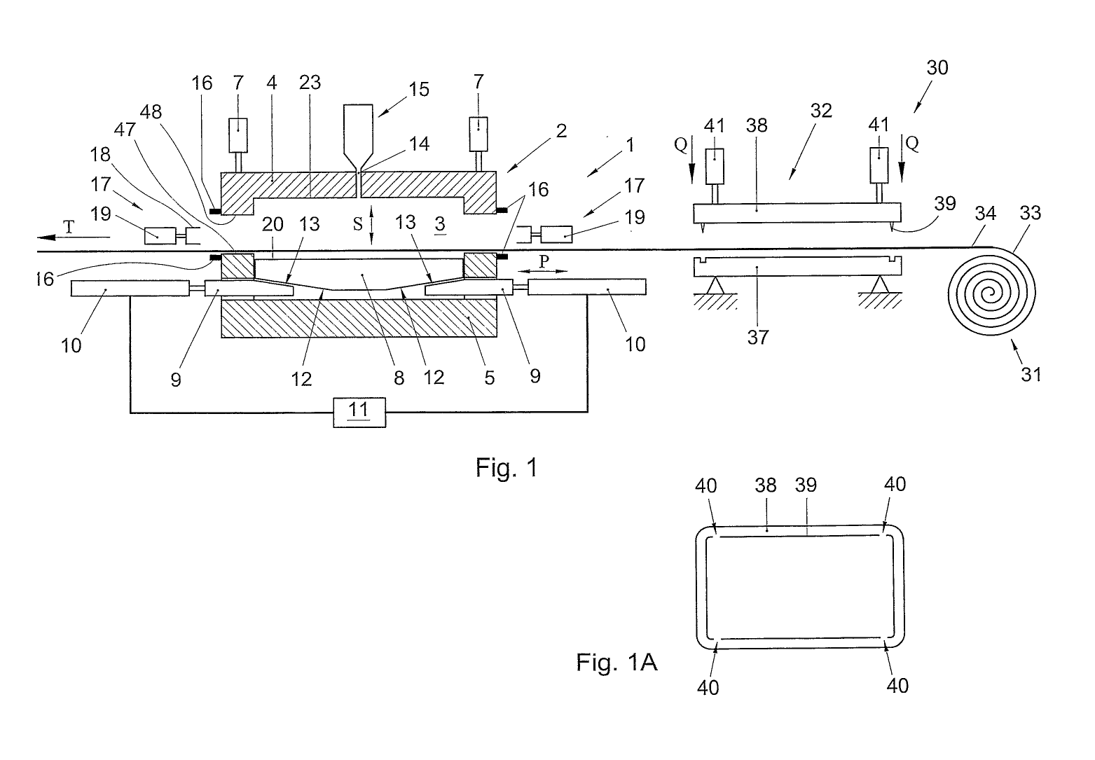

FIG. 1 shows, in partly cross-sectional side view, an apparatus according to the invention, with opened mold;

FIG. 1a shows an underside of a punching plate of a labeling station;

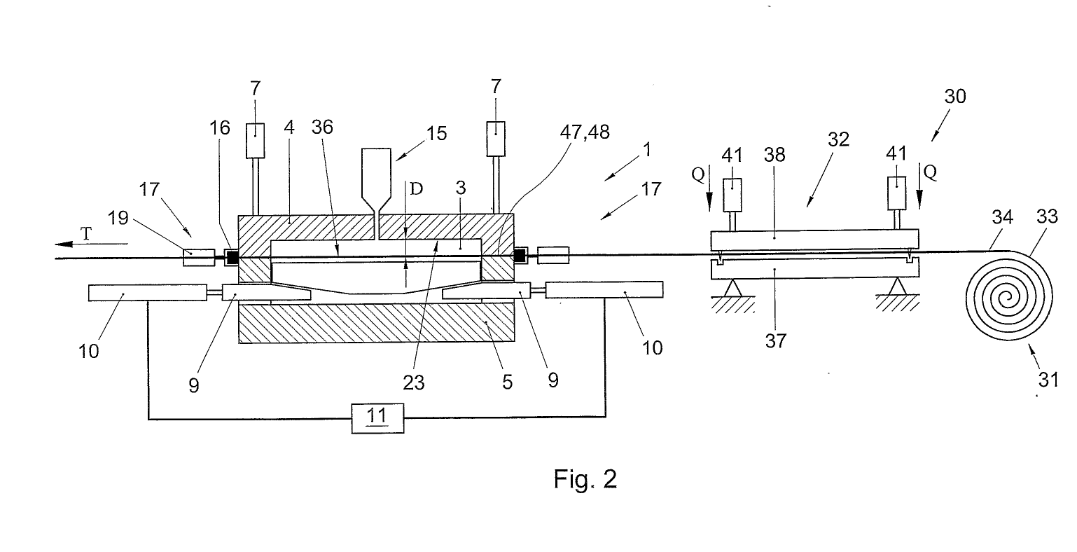

FIG. 2 shows, in partly cross-sectional side view, an apparatus according to the invention, with closed mold;

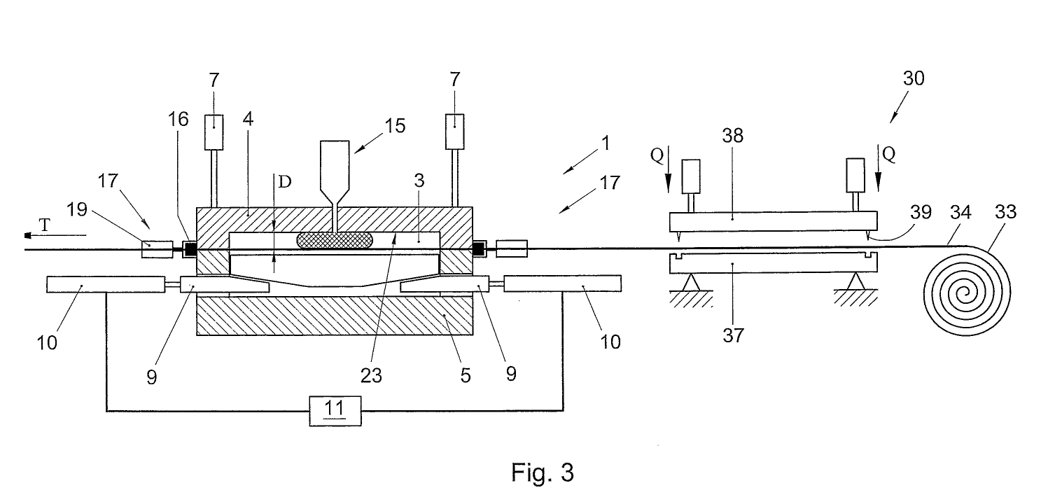

FIG. 3 shows, in partly cross-sectional side view, an apparatus according to the invention, during introduction of plastic in the mold cavity;

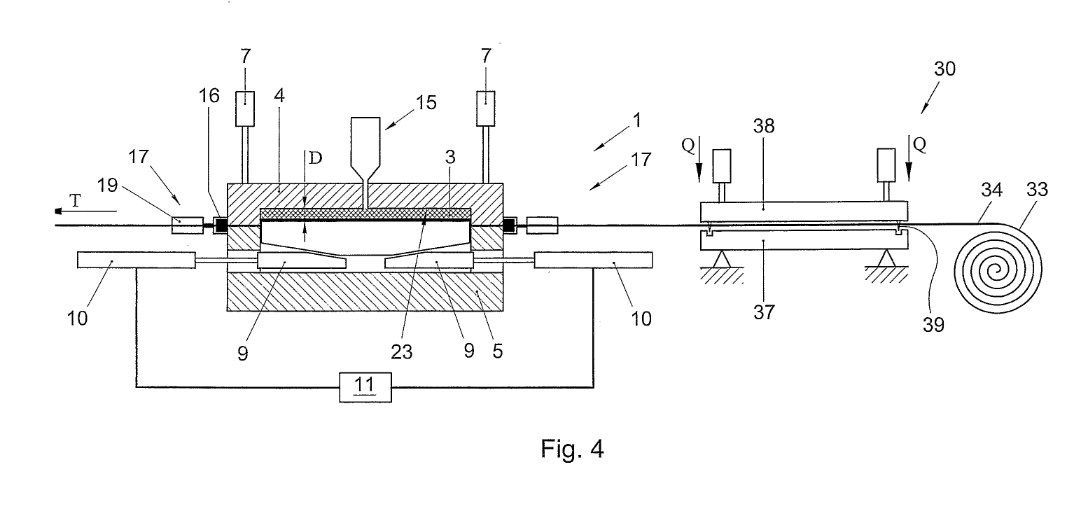

FIG. 4 shows, in partly cross-sectional side view, an apparatus according to the invention, after introduction of the plastic and forward movement of the at least one moveable wall part;

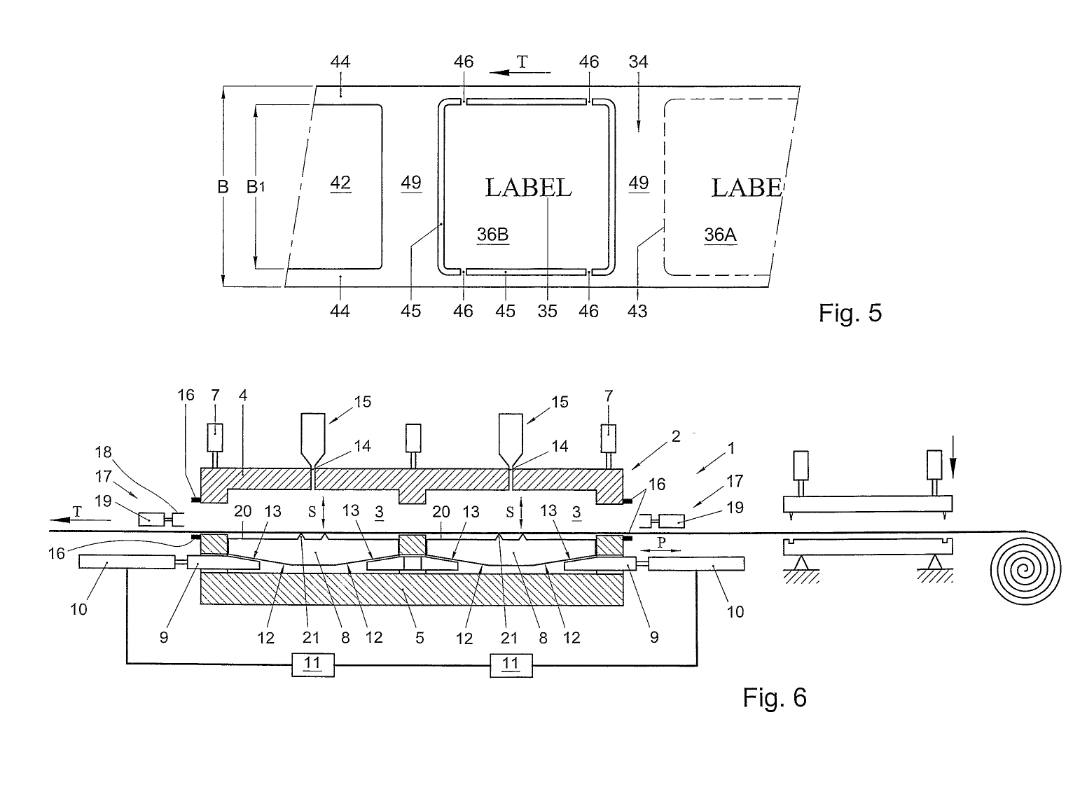

FIG. 5 shows, in top plan view, a strip of film with labels, one of which is partly punched out;

FIG. 6 shows, in partly cross-sectional side view, an alternative embodiment of a apparatus according to the invention, with opened mold; and

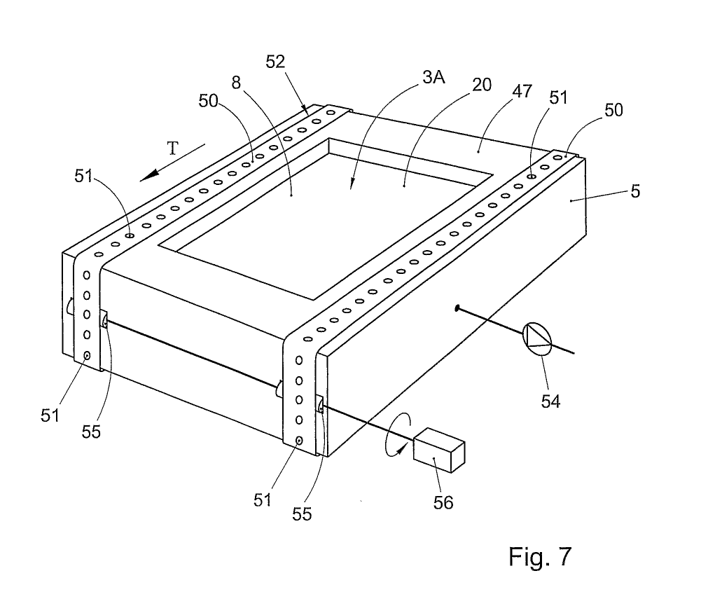

FIG. 7 shows, in perspective top plan view, a mold part with a part of a mold cavity and moveable wall part, and feed-through means for the strip of film included, at least partly, in a joining surface.

In this description, identical or corresponding parts have identical or corresponding reference numerals. The exemplary embodiments shown and described are merely shown by way of illustration and should not be construed to be limitative in any manner.

FIG. 1 shows, in cross-sectional side view, an apparatus 1 according to the invention, provided with a mold 2 with a mold cavity 3 therein. The mold comprises a first, moveable part 4 and a second, complementary part 5, fixedly arranged. The moveable part 4 is guided by suitable guides, which are not shown but can, for instance, be sliding pins, rails, guide rods of a press or the like and which are directly clear to the skilled person. The moveable part is moveable with the aid of apparatuses suitable to that end, represented in FIGS. 1-3 as piston-cylinder assemblies 7. It is clear that this may be any suitable apparatus, for instance also a simple press, screw means such as spindles as shown in FIG. 4, link systems or the like. These can be of relatively light design as they are only meant for moving the part 5, practically not for compensating for tensile or pressure forces in the further cycle.

In the fixed part 5, a slide 8 is provided, moveable in the direction S between a retracted position shown in FIGS. 1 and 2, and an extended position shown in FIG. 3. For moving the slide 8, two wedges 9 are provided, to be called wedge-shaped elements, which are moveable in a direction P with the aid of piston-cylinder assemblies 10 which are, for instance, hydraulically driven from a central control unit 11. The wedges 9 move in the direction P approximately at right angles to the direction S. At the underside, the slide 8 is provided with two surfaces 12 inclining in opposite directions, complementary to the top surfaces of the wedges 9, such that if the wedges 9 are moved inwards, towards each other, the slide 8 is moved upwards (directions viewed in the plane of the drawing) towards the extended position and vice versa.

An inflow opening 14 terminates in the mold cavity 3 and is connected to an injection apparatus 15, for instance a plasticizing apparatus and, optionally, a pressing apparatus. On both parts 4, 5 of the mold 2, flanges 16 are provided which, with the aid of blocking means 17, can be pressed and held onto each other, for keeping the mold closed. To that end, in the exemplary embodiment shown, the blocking means comprise brackets 18 which are moveable with the aid of piston-cylinder assemblies 19 and can be pushed over the flanges 16. In this way, the desired closing pressure can simply be obtained and maintained.

The distance D between the side 20 of the slide 8 leading in the direction of movement and the opposite surface 23 of the mold cavity is set with the slide 8 retracted, depending on the desired product wall thickness and the plastic to be used, the distance being set to be greater as the melt of the plastic is higher and/or the melting temperature of the plastic is lower.

In the drawing, next to the mold 2, a labeling station 30 is shown, comprising a feeder 31 and a punching apparatus 32. The feeder 31 comprises a roller 33 on which a strip of film 34 is wound. On this strip 34, a series of prints 35 (FIG. 5) are provided. These prints 35 are applied onto the labels and/or define them and/or are provided such that if labels 36 (FIG. 5) are cut out or punched out, on each label 36 at least one print is provided. The punching apparatus 32, which, for that matter, can also be designed as a cutting apparatus or combined cutting/punching apparatus, is included between the roller 33 and the mold 2, viewed in feed-through direction T in front of the mold. In the embodiment shown, the punching apparatus 32 comprises a base plate 37 which is fixedly arranged, and a punching plate 38 moveable relative thereto. At the underside, the punching plate has a cutting edge 39 as shown in FIG. 1A. This cutting edge 39 has the circumference of the labels 36 to be cut out, but is interrupted at a number of positions 40. The punching plate 38 is moveable in the cutting direction Q with the aid of operating means 41 such as piston cylinder assemblies. As a result, a label 36 is cut, to a large extent, from the strip of film 34, as shown in FIG. 5.

FIG. 5 shows in top plan view a strip of film 34, which may have any desired thickness between a few μm and tens of μm or even tenths of millimetres or more. On the strip, the prints 35 are shown. In FIG. 5, the feed-through direction T is represented from right to left. In the feed-through direction T are shown, successively, a label 36A not yet cut out (represented in interrupted lines 43) a substantially cut-out label 36B, and an opening 42 from which a label has been removed. On both sides of the labels 36A, B and the opening 42, a band 44 is provided in that the width B of the strip 34 is greater than the width B1 of the labels 36. As clearly appears from FIG. 5, the label 36B is substantially cut loose all around, indicated by the seam 45 while narrow bridges 46 of material have remained at the location where in the cutting edge 39 the interruptions 40 are provided. In this way, a fixed connection between bands 44 and label 36B is maintained and the strip 34 can be moved in the feed-through direction T by pulling the bands 44.

It will be clear that also, bridges 46 can be formed between the labels 36 and the intermediate part 49, next to or instead of the bridges 46 shown.

As appears from FIGS. 1-4, the strip 34 is moved between the joining surfaces or closing surfaces 47, 48 of the first and second mold part 4, 5. Preferably, the labels 36 have a form and dimensions corresponding to the mold cavity 3 in the mold, viewed in projected surface. Here, the label 36B is brought between the parts forming the mold cavity 3. Thereupon, the mold is closed so that the bands 44 and the intermediate parts 49 of the strip 34 are confined between the joining surfaces 47, 48, as shown in FIG. 2. At that moment, a subsequent label 36 can be punched out in the punching apparatus 32.

As shown in FIG. 2, the mold 2 is closed from the position shown in FIG. 1. The distance D is then set at a suitable value, such that the space in the mold cavity 3 is relatively great. Plastic is introduced through the inflow opening 14 at a relatively low pressure into the mold cavity, for instance at a pressure between 1 and 10 bars excess pressure, as shown in FIG. 3, against the side remote from the slide 8. The filling pressure is chosen such that a desired, short feed time is achieved without the material properties of the plastic being adversely affected and without undesired high pressure occurring in the mold cavity.

Then, preferably with relatively high speed, the slide 8 is moved forward, in the direction of the extended position, as shown in FIG. 4, through movement of the wedges 9. Here, the speed can be chosen such that adiabatic heat development occurs, which can be such that the temperature of the plastic is returned, at least substantially, to at least approximately the melting temperature thereof. Any plastic that may have somewhat solidified is made liquid again and can be forced further into the mold so that a complete filling of the mold cavity is obtained, while the product can have wall thicknesses which, in fact, are too small for the melt flow index of the respective plastic/product combination.

Through the movement of the slide 8, the label 36B is pressed from the strip 34 while breaking the bridges 46. The label 36B comes to rest on the side 20 of the slide 8 and is taken along therewith and pressed against the plastic. As a result, an intensive contact is obtained. Moreover, the label 36 then remains in the position and shape imposed by the side 20.

Optionally, after movement of the slide, some after-pressure can be given with the aid of the injection apparatus 50, so that undesired stresses can be pressed from the product.

Thereupon, the mold can be opened again and the product be taken out.

Preferably, the mold 2 is formed such that, with the mold closed and the slide retracted, the joining surfaces 47, 48 are approximately flush with the leading side 20 of the slide 8. As a result, the strip 34 abuts approximately against this side 20, or at a small distance therefrom, preferably less than the distance over which the slide 8 can move. In this way, the label 36 is taken along even better and cut off or torn loose from the bridges 46 in a neater way.

The rate of movement of the or each slide is preferably so high that the time of movement of the slide between the retracted and the extended position is relatively short with respect to the cycle time for the manufacture of a product, for instance between 0 and 10% of this time, depending also on the desired adiabatic heating. For each plastic/product combination this can be determined by experiments or be calculated with the aid of standard tables with respect to plastics, the product properties such as dimensions and flow paths, the friction that will occur upon movement of the slide and the heat capacity and melting temperature of the plastic.

In FIG. 6, an alternative embodiment of apparatus according to the intention is shown. In this embodiment, two mold cavities are arranged in feed through direction T one behind the other. This means that per injection molding cycle, two products can be made simultaneously. Here, ridges 21 are provided on the surface 20 of the slide 8, for forming hinges in the product to be formed. The label 36 can simply cover these. For each mold cavity 3, a separate injector 15 can be provided, but they can also be filled from a filling apparatus. Mold cavities can also be arranged one next to the other, as well as next to and behind each other, for multiple molds. In the labeling station, all labels can be cut loose simultaneously in one injection molding cycle, but this can also be done in different steps.

In FIG. 7, in perspective view, schematically, one mold half 5 of a mold 2 is shown, with a mold cavity forming part 3A therein, partly bounded by the slide 8 whose side 20 facing the cavity 3 is visible. On both sides of the cavity 3A, a conveyor belt 50 is provided, in which series of holes 51 are provided. In the closing surface 47, a vacuum path 52 is provided, under the conveyor belts 50, so that air can be drawn in through the holes 51 with the aid of a vacuum pump 54. The conveyor belts 50 can be moved through rotation of drive wheels 55 by a motor 56 or other suitable means. During use, the bands 44 of the strip 34 rest on the conveyor belts 50 and are sucked tight thereon. As a result, upon rotation of the wheels 55, the strip will be taken along in the feed through direction T. It is preferred that in both joining surfaces 47, 48 conveyor belts are provided which, however, need not both comprise vacuum means. Naturally, all sorts of other feed through means can be provided for that matter, for transport of the film strip 34 in the transport direction T.

Preferably, the movement means and the slide are designed such that adiabatic heat development occurs, so that the temperature in the material rises above the melting temperature of the respective material.

With an apparatus according to the invention, if adiabatic heat development is used, the mold can be held closed with relatively little closing pressure and the plastic can be introduced, in comparison with a conventional injection molding apparatus. By way of illustration, with conventional injection molding, feed pressures of between, for instance 350 bars and 1000 bars or more are used, with closing pressures of for instance, 0.25 to 1.25 ton/cm², depending on, in particular, the material used, the wall thickness and the maximum flow path. With a method according to the invention, for comparable products, a feed pressure of, for instance, between 0 and 200 bars excess pressure can suffice, while relatively low pressures are preferred, for instance some tens of bars or less, while the closing pressure can be, for instance, less than 0.2 ton/cm². With polypropylene for instance, a closing pressure of 0.025 to 0.1 ton/cm² instead of between 0.25 and 1.25 ton/cm² can suffice.

Without wishing to be bound to any theory, this appears, in particular, to be the result of the insight that by temporarily increasing the volume of the mold cavity, at least when introducing the larger part of the material such as the plastic into the mold cavity, the relation between the length of the flow paths and their passage, substantially determined by the minimum wall thickness of the product to be formed, becomes more favorable, so that the material experiences relatively little counter pressure in the mold cavity, while the injection opening or openings are so small that upon movement of the slide or slides, the material is not pushed back through this opening or these openings. Moreover, then, the advantage appears to be achieved that due to the high speed of the or each slide, as a result of friction, so much heat is introduced into the material that solidification of the material, in particular against the mold parts and in the flow front thereof, is undone so that the viscosity of the material is reduced again, while the remaining length of the flow paths for this flow front at the start of the movement of the or each slide has been considerably reduced relative to the original length thereof. As a result, the material can be distributed in the entire mold cavity with less pressure. As the mold is then closed, in a simple manner, the material is prevented from flowing away prematurely.

With a mold according to the invention, in the movement means, preferably, wedge-shaped elements are used, which, viewed from the mold cavity, are moved behind the or a slide, such that the respective slide is moved as a result of the wedge-shape. In particular, then, for each slide at least two wedge-shaped elements are used which are pushed in opposite directions behind the slide so that a symmetrical load is obtained. Through the use of such wedge-shaped elements, a favorable distribution of forces is obtained and the slides can be moved over the desired distance rapidly, with relatively little force. Naturally, also other movement means for the slides 8 can be provided.

In a mold according to the invention, preferably, at least one slide is provided at the location where the smallest wall thickness is provided in a product and/or at the location where the flow paths have the greatest length and/or at the location where the flow paths have the greatest complexity. By retracting the slides in those parts upon injection of the plastic, at least moving them partly from the mold cavity, additional space is created for allowing the plastic to pass exactly at the location where the plastic experiences the most resistance or at the location where excessive pressures would be necessary for allowing the plastic to pass. This holds in particular at the location where already some solidification of the plastic occurs. The adiabatic heat introduced later causes the plastic to flow further, while, moreover, the displacement of the slide effects the further movement of the plastic. Furthermore, with such a mold, relatively large, thin-walled product parts can be obtained with wall thicknesses that cannot be obtained with conventional injection molding technique.

Slides in a mold according to the invention preferably have a frontal surface which is relatively large in relation to the projected surface of the product. Herein, projected surface is understood to include the surface of the product projected on a surface at right angles to the closing direction of the mold. For instance, the frontal surface of the slide can be more than 20% of this projected surface. Surfaces of more than 50%, for instance of 75%, 85% or 95% or more are possible. With this, the advantage is achieved that in a major part of the mold cavity, the space for primary flow of the material to be formed is increased, while, eventually, thin-walled products can be manufactured. As a result of this as well, the feed pressure and the closing pressure can be kept even lower. Preferably, the or each slide 8 bearing a label has a frontal surface that corresponds to the size of the label 36 and is preferably equal to the projected surface of the mold cavity, at least of the part where the label is placed.

With such a method, in a rapid and simple manner, plastic products can be manufactured, while low pressures can be used for injection of the plastic as well as closure of the mold. As low injection pressures can be used, the advantage can be achieved that no undesired chemical or mechanical changes occur in the plastic, in particular separation in the different monomers or polymers, while the closing pressure can be kept low, which is advantageous from a point of view of costs. The fact is that for that purpose, simpler apparatuses are suitable, while moreover, the mechanical load is lower and less wear will occur. A further advantage thereof is that, in principle, less space is required for such an apparatus.

With a method according to the invention, after the mold cavity has been at least substantially filled, it is preferred that the or each slide is moved rapidly into the mold cavity, such that the eventual product shape is obtained. The speed of the or each slide is then set such that adiabatic heat development occurs in the plastic, so that the temperature is increased again to approximately the melting temperature thereof. As a result, partially solidified material will become liquid again and be pushed further into the mold cavity, while, furthermore, the remaining flow paths are relatively short so that relatively thin product parts can be formed.

With a method according to the invention, the rate of movement of the or each slide is preferably high, such that the complete movement of the slides is carried out in a fraction of the cycle time of a product cycle, for instance in less than 10%, more in particular in less than 3% of the cycle time, preferably less than some tenths or hundredths of seconds, more in particular microseconds. As stated, this rate is set such that the desired temperature increase occurs, while the plastic properties are prevented from being adversely thermally influenced.

With a method according to the invention, the distance between the end of the or each slide, leading in the direction of movement and facing the mold cavity in the retracted position, at least partly moved from the mold cavity, and an oppositely located wall part of the mold cavity or slide is set depending on at least the melt of the plastic, i.e. the viscosity of the plastic upon injection. Surprisingly, it has appeared that, preferably, at a higher melt, i.e. a higher viscosity, the distance is to be slightly greater than with a lower melt. Without wishing to be bound to any theory, this appears to be the result of the fact that the plastic with the higher melt will solidify sooner and the plastic with the lower melt has a more disadvantageous MFI. For any plastic/mold combination, the optimal distance can be determined in a simple manner by way of experiments.

It will be clear that several slides 8 can be provided in the same mold cavity, while one or more are designed for applying labels in the described manner. The order of movement of the slides can be selected at wish and is preferably such that the or each slide with a label is first brought forward before other slides reach an extended position. As a result, damage to the labels is prevented even better.

The labels can also be punched out in the mold cavity. Also, the plastic can be introduced after the label has been pressed loose from the strip and even when the slide 8 is already brought in the moved forward final position.

The invention is not limited in any manner to the embodiments represented in the drawing and the description. Many variations thereon are possible within the framework of the invention as outlined by the claims. For instance, a mold 2 according to the invention can comprise several mold cavities, while the or each mold cavity can be provided with one or more slides. The slides can be driven in other manners, for instance directly instead of with the wedges, and with the aid of other means, for instance electrically. The slides can also move in other directions, for instance approximately at right angles to the direction of movement of the mold parts, or be pivoted for reducing the space in the mold cavity.

These and many comparable adaptations are possible within the framework of the invention as outlined by the claims.

1. A method for the manufacture of plastic products in a mold, provided with at least one label, comprising the steps of:
feeding a strip of film comprising at least one label;
feeding-through the strip of film over a joining surface of the mold in 5 open condition such that said label is positioned between two parts of a mold cavity of the mold;
closing the mold such that said label is stored in said mold cavity;
moving a moveable wall part of the mold cavity within the mold cavity such that said label is pressed from said strip of film;
injecting plastic into the mold cavity for forming a product therein such that the label is attached to or on the product.

2. A method according to claim 1, wherein said at least one label is punched from said strip of film, prior to movement thereof between the said parts of the mold cavity such that the label is bounded on at least two sides by 15 a band of film, while said label remains connected to said bands of film at least two positions.

3. A method according to claim 1, wherein after forming the product, the mold is opened, the product is taken out and the strip of film is fed through further.

4. A method according to claim 1, wherein, on said strip, a series of labels are formed, in a feed-through direction one behind the other, which, in successive production cycles for products in the mold, are pressed from the strip.

5. A method according to claim 1, wherein the 25 step of injecting the plastic precedes the pressing of the label from the strip of film.

6. A method according to claim 5, wherein during injection of the plastic into the mold cavity, the label is pressed against said moveable wall part and after the plastic has been introduced into the mold cavity, the label is moved together with the moveable wall part in the direction of an opposite wall part, thereby partly displacing the plastic.

7. A method according to claim 1, wherein said moveable wall part is moved so rapidly that adiabatic heat development occurs in the plastic in the mold cavity such that the viscosity of at least a part of the plastic is reduced.

8. A method according to claim 1, wherein the strip of film is guided and/or fed through at least at the location of the mold cavity by means of vacuum controlled transport means provided on or near a joining surface of the mold.

9. An apparatus for the manufacture of labeled products, comprising feed through means for a strip of film, a mold with at least two mold parts and at least one mold cavity and injection means for introducing plastic into the at least one mold cavity, wherein the at least two mold parts each have a joining surface such that the mold parts are moveable between an opened position, in which the respective joining surfaces are situated at a distance from each other, and a closed position, in which the joining surfaces abut at least virtually against each other, while at least one wall part of the at least one mold cavity is moveable between a retracted position and an extended position, the feed through means extending along and/or over at least one of the closing surfaces such that during use, said strip of film extends along and/or through said at least one mold cavity, within the mold in closed condition and over said at least one moveable wall part, while drive means are provided for moving said moveable wall part from said retracted position to said extended position while taking along a label from said strip of film.

10. An apparatus according to claim 9, wherein the feed through apparatus defines a feed through direction, while in feed through direction in front of the mold, a labeling station is provided with cutting means and/or punching means for partly cutting out and/or punching out from said strip of film a label, preferably a series of labels, viewed in feed through direction one behind the other and at a mutual distance from each other.

11. An apparatus according to claim 10, wherein, viewed at right angles to the feed through direction, the labels have a maximum width which is smaller than the width of the strip of film, measured at the location of said maximum width of the label such that, viewed in feed through direction, on both sides of the or each label a band of film is provided.

12. An apparatus according to claim 10, wherein after cutting out or punching out a label, the respective label is at least connected to a part of the strip of film situated between two successive labels and/or a band of film extending or both sides of the respective label.

13. An apparatus according to claim 9, wherein a side of said moveable wall part proximal to the mold cavity extends, in retracted position, at least partly in or near a closing plane of the respective mold part such that with the mold closed, the strip of film extends at a relatively small distance from, and preferably against said side of said moveable wall part.

14. An apparatus according to claim 9, wherein the feed through means extend at least partly in or along at least one of the closing surfaces.
